(19) United States
(12) Patent Application Publication
(10) Pub. No.: US 2014/0169774 A1
(43) Pub. Date: Jun. 19, 2014

(54) WATER HEATING ASSEMBLY FOR A REFRIGERATOR APPLIANCE

(71) Applicant: GENERAL ELECTRIC COMPANY, Schenectady, NY (US)

(72) Inventors: Brent Alden Junge, Evansville, IN (US); Vineeth Vijayan, Louisville, KY (US)

(73) Assignee: GENERAL ELECTRIC COMPANY, Schenectady, NY (US)

(21) Appl. No.: 13/717,819

(22) Filed: Dec. 18, 2012

(51) Int. Cl. F24H 1/00; B67D 7/82

(52) U.S. Cl. CPC B67D 7/82; F24H 1/0018
USPC 392/449; 222/146.5

(57) ABSTRACT

A water heating assembly for a refrigerator appliance is provided. The water heating assembly includes a vacuum insulated container and a heating element received within a heated chamber of the vacuum insulated container for heating water therein. An inlet conduit is configured for directing water into the heated chamber, and an outlet conduit is configured for directing heated water out of the heated chamber.

### FIELD OF THE INVENTION

The present subject matter relates generally to refrigerator appliances and water heating assemblies for the same.

### BACKGROUND OF THE INVENTION

Certain refrigerator appliances include a dispenser for directing ice from the refrigerator's ice maker and/or water to the dispenser. In particular, a user can activate the dispenser to direct a flow of ice or water into a cup positioned within the dispenser. Water directed to the dispenser is generally chilled or at an ambient temperature. However, the user may desire heated water rather than relatively cool water.

Refrigerator appliances are generally not connected to a residential hot water heater. Further, connecting refrigerator appliances to residential hot water heaters can have certain drawbacks. For example, certain consumers dislike drinking or consuming heated water from residential hot water heaters because such heated water is generally not filtered. Such consumers may also dislike the taste of such heated water. Further, heated water from residential hot water heaters is generally heated to about one-hundred and forty degrees Fahrenheit, e.g., to avoid scalding and save energy. However, certain foods and beverages can require hotter water. For example, consumers can prefer coffee, tea and oatmeal mixed with hotter water.

To provide hot water, certain refrigerator appliances include features for heating water. In particular, such refrigerator appliances can include a water heating element that a user can activate in order to receive heated water at the dispenser. Such systems have drawbacks. In particular, the water heating element can have a maximum power output of about seven-hundred and fifty watts due to current restrictions of residence electrical systems. Thus, the water heating element can take several minutes to heat water to a suitable temperature. Waiting for heated water can be undesirable and inconvenient.

Accordingly, a refrigerator appliance with features for providing heated water would be useful. In particular, a refrigerator appliance with features for maintaining a volume of heated water would be useful. Further, a refrigerator appliance with features for providing heated water without a significant lag time would be useful

### BRIEF DESCRIPTION OF THE INVENTION

The present subject matter provides a water heating assembly for a refrigerator appliance. The water heating assembly includes a vacuum insulated container and a heating element received within a heated chamber of the vacuum insulated container for heating water therein. An inlet conduit is configured for directing water into the heated chamber, and an outlet conduit is configured for directing heated water out of the heated chamber. Additional aspects and advantages of the invention will be set forth in part in the following description, or may be apparent from the description, or may be learned through practice of the invention.

In a first exemplary embodiment, a refrigerator appliance is provided. The refrigerator appliance includes a cabinet that defines a chilled chamber for receipt of food items for storage. A door is rotatably mounted to the cabinet and configured for permitting selective access to the chilled chamber of the cabinet. A dispenser is mounted to the door. A water heating assembly is also provided for directing a flow of heated water to the dispenser. The water heating assembly includes a vacuum insulated container that defines a heated chamber. A heating element is received within the heated chamber of the vacuum insulated container and is configured for heating water within the heated chamber of the vacuum insulated container. An inlet conduit and an outlet conduit are also provided. The inlet conduit is configured for directing a flow of water into the heated chamber of the vacuum insulated container. The outlet conduit is configured for directing a flow of heated water out of the heated chamber of the vacuum insulated container.

In a second exemplary embodiment, a water heating assembly for a refrigerator appliance is provided. The water heating assembly includes a vacuum insulated container that defines a heated chamber. The heated chamber of the vacuum insulated container has a volume less than about thirty fluid ounces. A heating element is received within the heated chamber of the vacuum insulated container and is configured for heating water within the heated chamber of the vacuum insulated container. An inlet conduit and an outlet conduit are also provided. The inlet conduit is configured for directing a flow of water into the heated chamber of the vacuum insulated container. The outlet conduit is configured for directing a flow of heated water out of the heated chamber of the vacuum insulated container.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, elevation view of a refrigerator appliance according to an exemplary embodiment of the present subject matter.

FIG. 2 provides a schematic view of a water heating assembly according to an exemplary embodiment of the present subject matter.

FIG. 3 provides a schematic view of a water heating assembly according to an additional exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

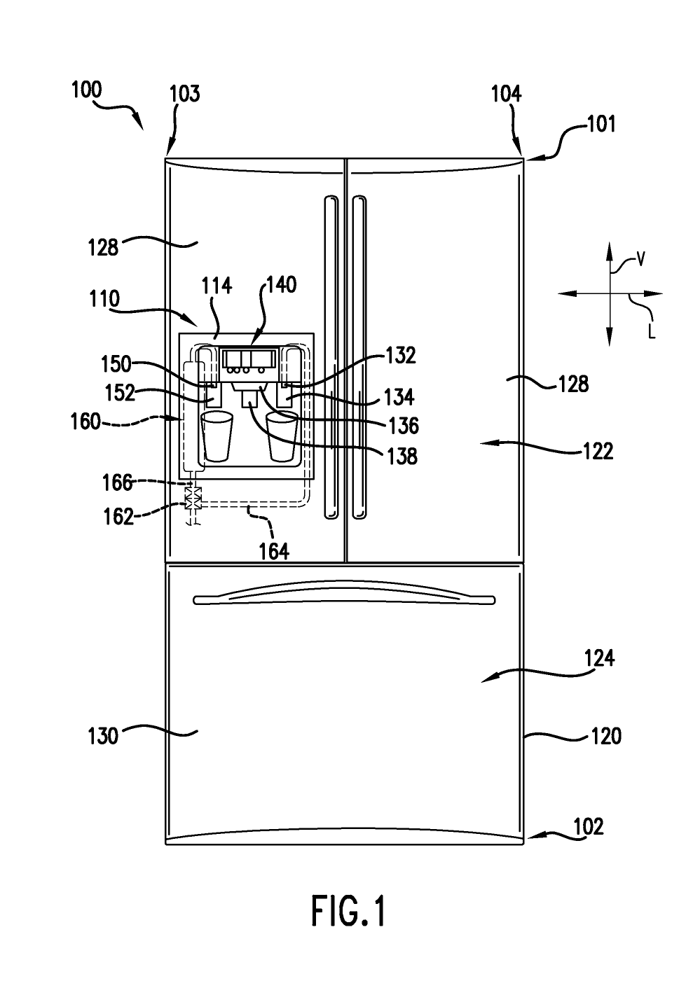

FIG. 1 provides a front, elevation view of a refrigerator appliance 100 according to an exemplary embodiment of the present subject matter. Refrigerator appliance 100 includes a cabinet or housing 120. Housing 120 extends between an upper portion 101 and a lower portion 102 along a vertical direction V and also extends between a first side portion 103 and a second side portion 104 along a lateral direction L. Housing 120 defines chilled chambers, e.g., a fresh food compartment 122 positioned adjacent upper portion 101 of housing 120 and a freezer compartment 124 arranged at lower portion 102 of housing 120. Housing 120 also defines a mechanical compartment (not shown) for receipt of a sealed cooling system for cooling fresh food compartment 122 and freezer compartment 124.

Refrigerator appliance 100 is generally referred to as a bottom mount refrigerator appliance. However, it should be understood that refrigerator appliance 100 is provided by way of example only. Thus, the present subject matter is not limited to refrigerator appliance 100 and may be utilized in any suitable refrigerator appliance. For example, one of skill in the art will understand that the present subject matter may be used with side-by-side style refrigerator appliances or top mount refrigerator appliances as well.

Refrigerator doors 128 are rotatably hinged to an edge of housing 120 for accessing fresh food compartment 122. A freezer door 130 is arranged below refrigerator doors 128 for accessing freezer compartment 124. Freezer door 130 is mounted to a freezer drawer (not shown) slidably coupled within freezer compartment 124.

Refrigerator appliance 100 also includes an ice-dispensing assembly 110 for dispensing water and/or ice. Ice-dispensing assembly 110 includes a dispenser 114 positioned on an exterior portion of refrigerator appliance 100. Dispenser 114 includes several outlets for accessing ice, chilled water, and heated water. In particular, a chilled water paddle 134 is mounted below a chilled water outlet 132 for accessing chilled water, and a heated water paddle 152 is mounted below a heated water outlet 150 for accessing heated water. Similarly, an ice paddle 138 is mounted below an ice outlet 136 for accessing ice. As an example, a user can urge a vessel such as a cup against any of chilled water paddle 134, heated water paddle 152, and/or ice paddle 138 to initiate a flow of chilled water, heated water, and/or ice into the vessel, respectively.

A user interface panel 140 is provided for controlling the mode of operation of dispenser 114, e.g., for selecting crushed or whole ice. In additional exemplary embodiments, refrigerator appliance 100 may include a single outlet and paddle rather than three separate paddles and dispensers. In such embodiments, user interface panel 140 can include a chilled water dispensing button (not labeled), an ice-dispensing button (not labeled), and a heated water dispensing button (not labeled) for selecting between chilled water, heated water, and ice, respectively.

Outlets 132, 136, and 150 and paddles 134, 138, and 152 are an external part of dispenser 114, and are mounted in a concave portion of dispenser 114 defined in an outside surface of refrigerator door 128. Dispenser 114 is positioned at a predetermined elevation convenient for a user to access ice or water, e.g., enabling the user to access ice without the need to bend-over and without the need to access freezer compartment 124. In the exemplary embodiment, dispenser 114 is positioned at a level that approximates the chest level of a user.

Refrigerator appliance 100 also includes features for generating heated water. Thus, refrigerator appliance 100 need not be connected to a residential hot water heating system in order to supply heated water to heated water outlet 150. In particular, refrigerator appliance 100 includes a water heating assembly 160 mounted within refrigerator door 128 for heating water therein. Refrigerator appliance 100 includes a tee-joint 162 for splitting a flow of water. Tee-joint 162 directs water to both a heated water conduit 166 and a chilled water conduit 164.

Heated water conduit 166 is in fluid communication with water heating assembly 160 and heated water outlet 150. Thus, water from tee joint 162 can pass through water heating assembly 160 and exit refrigerator appliance 100 at heated water outlet 150 as heated water. Conversely, chilled water conduit 164 is in fluid communication with chilled water outlet 132. Thus, water from tee joint 162 can exit refrigerator appliance 100 as chilled water at chilled water outlet 132.

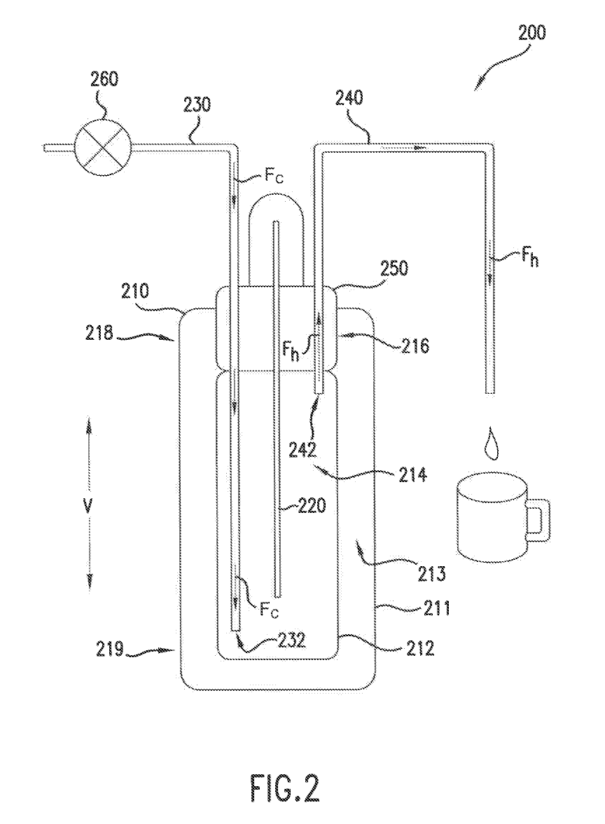

FIG. 2 provides a schematic view of a water heating assembly 200 according to an exemplary embodiment of the present subject matter. Water heating assembly 200 may be utilized in a refrigerator appliance, e.g., refrigerator appliance 100 as water heating assembly 160 (FIG. 1). Water heating assembly 200 is configured for generating heated water as discussed in greater detail below.

Water heating assembly 200 includes a vacuum flask or vacuum insulated container 210. Vacuum insulated container 210 includes an outer wall 211 and an inner wall 212. Outer and inner walls 211 and 212 define a vacuum volume 213 therebetween. Vacuum volume 213 contains very little gas relative to the ambient atmosphere in order to assist with insulating contents of vacuum insulated container 210.

Vacuum insulated container 210 defines a heated chamber 214. In particular, inner wall 212 defines heated chamber 214 such that inner wall 212 is disposed between vacuum volume 213 and heated chamber 214. Heated chamber 214 may have any suitable volume. For example, heated chamber 214 may have a volume less than about one-hundred fluid ounces, less than about fifty fluid ounces, less than about thirty fluid ounces, or less than about twenty fluid ounces. Heated chamber 214 is configured for containing water as discussed in greater detail below.

Vacuum insulated container 210 also defines an opening 216. Opening 216 permits access to heated chamber 214 of vacuum insulated container 210. Vacuum insulated container 210 extends between a top portion 218 and a bottom portion 219 along the vertical direction V. Top portion 218 of vacuum insulated container 210 is positioned above bottom portion 219 of vacuum insulated container 210 along the vertical direction V. In the exemplary embodiment shown in FIG. 2, opening 216 is positioned adjacent top portion 218 of vacuum insulated container 210.

A cap 250 is mounted to vacuum insulated container 210 at opening 216 of vacuum insulated container 210. Cap 250 assists with sealing heated chamber 214 of vacuum insulated container 210. In particular, cap 250 can assist with hindering heat flow out of heated chamber 214 through opening 216. Cap 250 can be mounted at opening 216 utilizing any suitable method. For example, cap 250 may be threaded to vacuum insulated container 210. Alternatively, cap 250 may be mounted to vacuum insulated container 210 using an adhesive or interference fit.

Water heating assembly 200 also includes a heating element 220 that is received within heated chamber 214 of vacuum insulated container 210. Heating element 220 is configured for heating water within heated chamber 214. Heating element 220 may be any suitable heating element. For example, heating element 220 may be an electrical resistance heating element. Heating element 220 is mounted to cap 250 and extends into heated chamber 214 for heating water therein as discussed in greater detail below.

Heating element 220 may have any suitable power output. For example, after heated water is dispensed from heated chamber 214 of vacuum insulated container 210, heating element 220 can operate in a recovery mode or phase in which relatively cool water entering heated chamber 214 is heated. During such recovery mode, heating element 220 can have a power output between about ten watts and about seven-hundred and fifty watts. After the water within heated chamber 214 reaches a suitable temperature, e.g., about one-hundred and eighty degrees Fahrenheit, heating element 220 can operate in a maintenance mode or phase in which heating element 220 operates to maintain water within heated chamber 214 at a predetermined temperature or within a predetermined range of temperatures. In such maintenance mode, heating element 220 may have a power output of about four watts, about three watts, about two watts, about one watt, less than about one watt, between about three watts and about one watt, or less than about four watts.

An inlet conduit 230 is configured for directing a flow of water (shown with arrows F_{c}) into heated chamber 214 of vacuum insulated container 210. In particular, inlet conduit 230 passes through opening 216 of vacuum insulated container 210 in order to direct the flow of water F_{c} through opening 216 and into heated chamber 214. Inlet conduit 230 has an outlet 232 positioned proximate bottom portion 219 of vacuum insulated container 210. The flow of water F_{c} exits inlet conduit 230 and enters heated chamber 214 at outlet 232. Inlet conduit 230 may be mounted to cap 250 or any other suitable component of water heating assembly 200 or refrigerator appliance 100 (FIG. 1). Water heating assembly 200 also includes a valve 260 for regulating or controlling the flow of water F_{c} through inlet conduit 230.

An outlet conduit 240 is configured for directing a flow of heated water (shown with arrows Fₕ) out of heated chamber 214 of vacuum insulated container 210. In particular, outlet conduit 240 passes through opening 216 of vacuum insulated container 210 in order to direct the flow of heated water Fₕ through opening 216 and out of heated chamber 214. Outlet conduit 240 has an inlet 242 positioned proximate top portion 218 of vacuum insulated container 210. The flow of heated water Fₕ exits heated chamber 214 and enters outlet conduit 240 at inlet 242. Outlet conduit 240 may be mounted to cap 250 or any other suitable component of water heating assembly 200 or refrigerator appliance 100 (FIG. 1).

As an example, valve 260 can permit flow of water F_{c} to fill heated chamber 214 of vacuum insulated container 210 through inlet conduit 230. Within heated chamber such water can be heated with heating element 220. As will be understood by those skilled in the art, water heated by heating element 220 will rise within heated chamber 214. Thus, heated water and relatively cooler water will segregate within heated chamber 214 such that the heated water collects near top portion 218 of vacuum insulated container 210 adjacent inlet 242 of outlet conduit 240. In turn, outlet conduit 240 can direct flow of heated water Fₕ out of heated chamber 214, e.g., to dispenser 114 of refrigerator appliance 100 (FIG. 1) and a user.

Heated volume 214 can hold water heated to about one-hundred and eighty degrees Fahrenheit for long periods of time without the temperature of the heated water dropping significantly due to vacuum insulated container 210. Thus, water heating assembly 200 can supply heated water to a user on demand without a significant time lag. Further, heating element 220 can have a low power output due to vacuum insulated container 210 such that water heating assembly 200 has relatively high energy efficiency despite holding heated water within heated chamber 214.

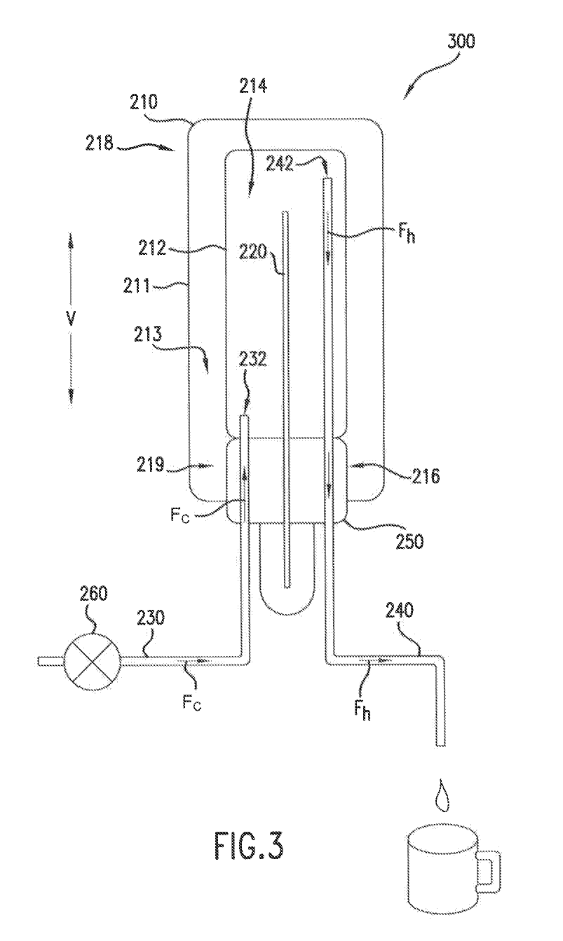

FIG. 3 provides a schematic view of a water heating assembly 300 according to an additional exemplary embodiment of the present subject matter. Water heating assembly 300 is similar to water heating assembly 200 (FIG. 2). However, vacuum insulated container 210 is oriented in a different manner in water heating assembly 300. In particular, opening 216 of vacuum insulated container 210 is positioned adjacent bottom portion 219 of vacuum insulated container 210 rather than bottom portion 218. Further, outlet 232 of inlet conduit 230 is positioned proximate top portion 218 of vacuum insulated container 210, and inlet 242 of outlet conduit 240 is positioned proximate bottom portion 219 of vacuum insulated container 210. Water heating assembly 300 operates in a similar manner to water heating assembly 200 described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A refrigerator appliance, comprising:
a cabinet defining a chilled chamber for receipt of food items for storage;
a door rotatably mounted to said cabinet and configured for permitting selective access to the chilled chamber of said cabinet;
a dispenser mounted to said door;
a water heating assembly for directing a flow of heated water to said dispenser, said water heating assembly comprising:
a vacuum insulated container defining a heated chamber;
a heating element received within the heated chamber of said vacuum insulated container and configured for heating water within the heated chamber of said vacuum insulated container;
an inlet conduit for directing a flow of water into the heated chamber of said vacuum insulated container; and
an outlet conduit for directing a flow of heated water out of the heated chamber of said vacuum insulated container.

2. The refrigerator appliance of claim 1, wherein said vacuum insulated container defines an opening that permits access to the heated chamber of said vacuum insulated container, said water heating assembly further comprising a cap mounted to said vacuum insulated container at the opening of said vacuum insulated container in order to assist with sealing the heated chamber of said vacuum insulated container.

3. The refrigerator appliance of claim 2, wherein said heating element, said inlet conduit, and said outlet conduit are mounted to said cap.

4. The refrigerator appliance of claim 1, wherein the heated chamber of said vacuum insulated container has a volume less than thirty fluid ounces.

5. The refrigerator appliance of claim 1, wherein said vacuum insulated container defines a vertical direction, said vacuum insulated container extending between a top portion and a bottom portion along the vertical direction, said vacuum insulated container also defining an opening that permits access to the heated chamber of said vacuum insulated container, the opening of said vacuum insulated container positioned at the top portion of said vacuum insulated container.

6. The refrigerator appliance of claim 5, wherein said inlet conduit has an outlet positioned proximate the bottom portion of said vacuum insulated container, said outlet conduit having an inlet positioned proximate the top portion of said vacuum insulated container.

7. The refrigerator appliance of claim 1, wherein said vacuum insulated container defines a vertical direction, said vacuum insulated container extending between a top portion and a bottom portion along the vertical direction, said vacuum insulated container also defining an opening that permits access to the heated chamber of said vacuum insulated container, the opening of said vacuum insulated container positioned at the bottom portion of said vacuum insulated container.

8. The refrigerator appliance of claim 7, wherein said inlet conduit has an outlet positioned proximate the bottom portion of said vacuum insulated container, said outlet conduit having an inlet positioned proximate the top portion of said vacuum insulated container.

9. The refrigerator appliance of claim 1, wherein said heating element has a power output of less than four watts during a maintenance phase.

10. The refrigerator appliance of claim 1, wherein said vacuum insulated container is mounted within said door.

11. The refrigerator appliance of claim 1, wherein said vacuum insulated container is removably mounted within said dispenser.

12. A water heating assembly for a refrigerator appliance, comprising:
a vacuum insulated container that defines a heated chamber, the heated chamber of said vacuum insulated container having a volume less than thirty fluid ounces;
a heating element received within the heated chamber of said vacuum insulated container and configured for heating water within the heated chamber of said vacuum insulated container;
an inlet conduit for directing a flow of water into the heated chamber of said vacuum insulated container; and
an outlet conduit for directing a flow of heated water out of the heated chamber of said vacuum insulated container.

13. The water heating assembly of claim 12, wherein said vacuum insulated container defines an opening that permits access to the heated chamber of said vacuum insulated container, the water heating assembly further comprising a cap mounted to said vacuum insulated container at the opening of said vacuum insulated container in order to assist with sealing the heated chamber of said vacuum insulated container.

14. The water heating assembly of claim 13, wherein said heating element, said inlet conduit, and said outlet conduit are mounted to said cap.

15. The water heating assembly of claim 12, wherein said vacuum insulated container defines a vertical direction, said vacuum insulated container extending between a top portion and a bottom portion along the vertical direction, said vacuum insulated container also defining an opening that permits access to the heated chamber of said vacuum insulated container, the opening of said vacuum insulated container positioned at the top portion of said vacuum insulated container.

16. The water heating assembly of claim 15, wherein said inlet conduit has an outlet positioned proximate the bottom portion of said vacuum insulated container, said outlet conduit having an inlet positioned proximate the top portion of said vacuum insulated container.

17. The water heating assembly of claim 12, wherein said vacuum insulated container defines a vertical direction, said vacuum insulated container extending between a top portion and a bottom portion along the vertical direction, said vacuum insulated container also defining an opening that permits access to the heated chamber of said vacuum insulated container, the opening of said vacuum insulated container positioned at the bottom portion of said vacuum insulated container.

18. The water heating assembly of claim 17, wherein said inlet conduit has an outlet positioned proximate the bottom portion of said vacuum insulated container, said outlet conduit having an inlet positioned proximate the top portion of said vacuum insulated container.

19. The water heating assembly of claim 12, wherein said heating element has a power output of less than four watts during a maintenance phase.
